(19) United States
(12) Patent Application Publication
(10) Pub. No.: US 2018/0213039 A1
(43) Pub. Date: Jul. 26, 2018

(54) INFORMATION PROCESSING APPARATUS AND COMMUNICATION SYSTEM

(71) Applicant: FUJI XEROX CO., LTD., Tokyo (JP)

(72) Inventors: Kenji KUROISHI, Kanagawa (JP); Chigusa NAKATA, Kanagawa (JP); Hiroshi HONDA, Kanagawa (JP); Yoshihiro SEKINE, Kanagawa (JP); Hiroshi MIKURIYA, Kanagawa (JP); Takeshi FURUYA, Kanagawa (JP); Ryuichi ISHIZUKA, Kanagawa (JP); Eiji NISHI, Kanagawa (JP)

(73) Assignee: FUJI XEROX CO., LTD., Tokyo (JP)

(21) Appl. No.: 15/718,175

(22) Filed: Sep. 28, 2017

(30) Foreign Application Priority Data
Jan. 26, 2017 (JP) 2017-012359

(51) Int. Cl. H04L 29/08; H04L 7/00

(52) U.S. Cl. CPC H04L 67/141; H04L 7/0033

(57) ABSTRACT

An information processing apparatus includes a communication unit and a communication controller. The communication unit communicates with an external apparatus with which communication is enabled for a limited period. In a predetermined period including a period which is set as the limited period for which communication with the external apparatus is enabled, the communication controller controls the communication unit so as to establish, for communication, a connection with the external apparatus.

### CROSS-REFERENCE TO RELATED APPLICATIONS

This application is based on and claims priority under 35 USC 119 from Japanese Patent Application No. 2017-012359 filed Jan. 26, 2017.

### BACKGROUND

### (i) Technical Field

The present invention relates to an information processing apparatus and a communication system.

### (ii) Related Art

Systems are being used in which multiple terminal apparatuses, having sensors, are connected to a management apparatus over a network and information obtained by the sensors included in the terminal apparatuses is collected.

### SUMMARY

According to an aspect of the invention, there is provided a circuit including an information processing apparatus including a communication unit and a communication controller. The communication unit communicates with an external apparatus with which communication is enabled for a limited period. In a predetermined period including a period which is set as the limited period for which communication with the external apparatus is enabled, the communication controller controls the communication unit so as to establish, for communication, a connection with the external apparatus.

### BRIEF DESCRIPTION OF THE DRAWINGS

Exemplary embodiments of the present invention will be described in detail based on the following figures, wherein:

FIG. 1 is a diagram illustrating the overall configuration of a terminal management system according to an exemplary embodiment;

FIG. 2 is a diagram illustrating the hardware configuration of a management server;

FIG. 3 is a diagram illustrating the functional configuration of the management server;

FIG. 4 is a diagram illustrating a relationship between a period for which a sensor data acquiring unit is in a state in which data may be received and a period (timing) in which a terminal apparatus transmits sensor data;

FIG. 5 is a diagram illustrating how a notifying unit detects a terminal apparatus that is not operating normally;

FIG. 6 is a diagram illustrating the hardware configuration of a terminal apparatus;

FIG. 7 is a diagram illustrating the functional configuration of a terminal apparatus;

FIG. 8 is a diagram illustrating the functional configuration of a multifunction device serving as an exemplary management server; and

FIG. 9 is a diagram illustrating a form of communication between the management server and a terminal apparatus.

### DETAILED DESCRIPTION

Exemplary embodiments of the present invention will be described in detail below with reference to the attached drawings.

A System to which the Exemplary Embodiment is Applied

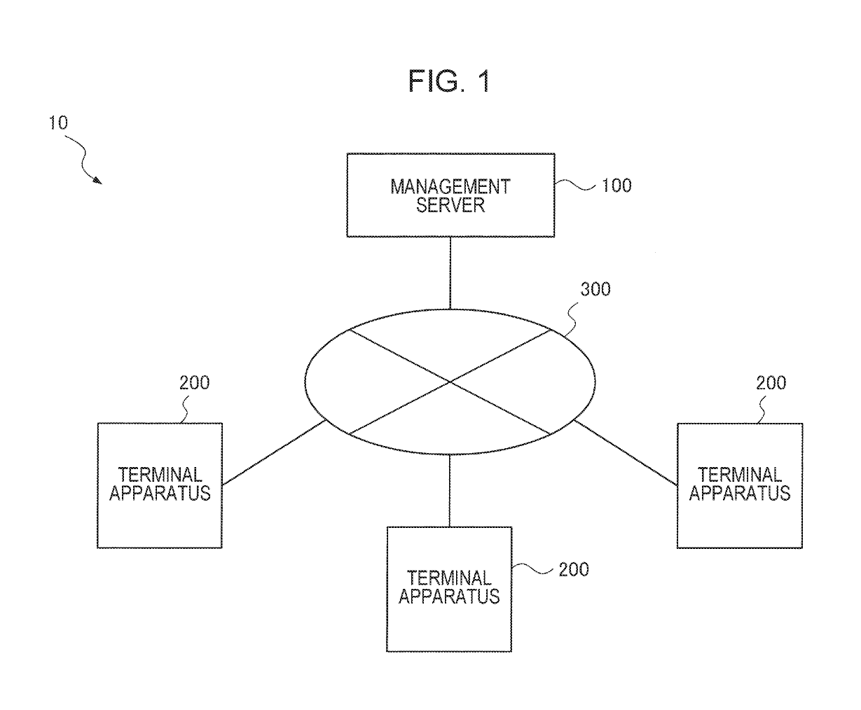

FIG. 1 is a diagram illustrating the overall configuration of a terminal management system according to an exemplary embodiment. A terminal management system 10 illustrated in FIG. 1 includes a management server 100 and terminal apparatuses 200 that are to be managed, and also includes a communication system between the management server 100 and the terminal apparatuses 200. The management server 100 is connected to the terminal apparatuses 200 over a network 300. The management server 100 itself may be connected to another server (external server) over the network 300 (not illustrated in FIG. 1). In this case, the management server 100 functions as a so-called edge server in an information system including other servers on a network.

The management server 100 is an exemplary terminal management apparatus that manages the terminal apparatuses 200, and is implemented, for example, by using a personal computer, a server machine, or any of various information processing apparatuses provided with a communication function. For example, an image processing apparatus that is a multifunction device having a copying function, an image reading function, a printing function, a fax communication function, and the like, and also having a communication function for performing data communication over the network 300 may be used as the management server 100.

The management server 100 that manages the terminal apparatuses 200 receives information from the terminal apparatuses 200 and transmits control instructions to the terminal apparatuses 200. The management server 100 may be provided with multiple network interfaces in order to be connected to multiple types of network lines. For example, the management server 100 may include a network adapter for connection with a local area network (LAN) through wired communication and a wireless communication module for connection with a LAN through wireless communication. For example, the management server 100 may include wireless communication modules supporting communication systems for connection with a LAN through wireless communication using Wi-Fi®, Bluetooth®, ZigBee®, and the like. Further, the management server 100 may include, as a network interface, a communication module for connection using a line for the long term evolution (LTE), the 3rd generation (3G), or the like and a communication module for connection using a fax communication line (telephone line).

The terminal apparatuses 200 are electronic equipment having an information acquiring section for acquiring various types of information and a communication function for performing communication over the network 300. The information acquiring section is a unit that acquires various types of environmental information as physical quantities of temperature, humidity, illumination, acceleration, and the like. For example, various sensors that obtain these physical quantities are used. That is, the terminal apparatuses 200 are so-called sensor devices. The terminal apparatuses 200 each include specific sensors in accordance with the type of the terminal apparatus 200. The terminal apparatuses 200 use the communication function to transmit information obtained from the sensors, to the management server 100 over the network 300. The information acquiring section of each of the terminal apparatus 200 is not limited to the same type, and may have a different type of information acquiring section and a different type of operation section depending on the terminal apparatus 200. Further, a single terminal apparatus 200 may have multiple types of information acquiring sections. In the exemplary embodiment, the terminal apparatus 200 is installed at a different location depending on information that is to be obtained. Therefore, the physical positional relationship between the management server 100 and a terminal apparatus 200 is different from the physical positional relationship between the management server 100 and another terminal apparatus 200. An appropriate communication line for connecting the management server 100 to a terminal apparatus 200 may be selected in accordance with the type (model) of the terminal apparatus 200 and the installation location of the terminal apparatus 200.

The network 300 is not particularly limiting as long as it is a communication network used in data communication between the management server 100 and the terminal apparatuses 200. For example, the network 300 may be a LAN, a wide area network (WAN), or the Internet. As described above, communication lines used in data communication may be various lines, regardless of whether they are wired or wireless. In addition, the apparatuses may be connected to one another through multiple networks and communication lines.

### The Configuration of the Management Server

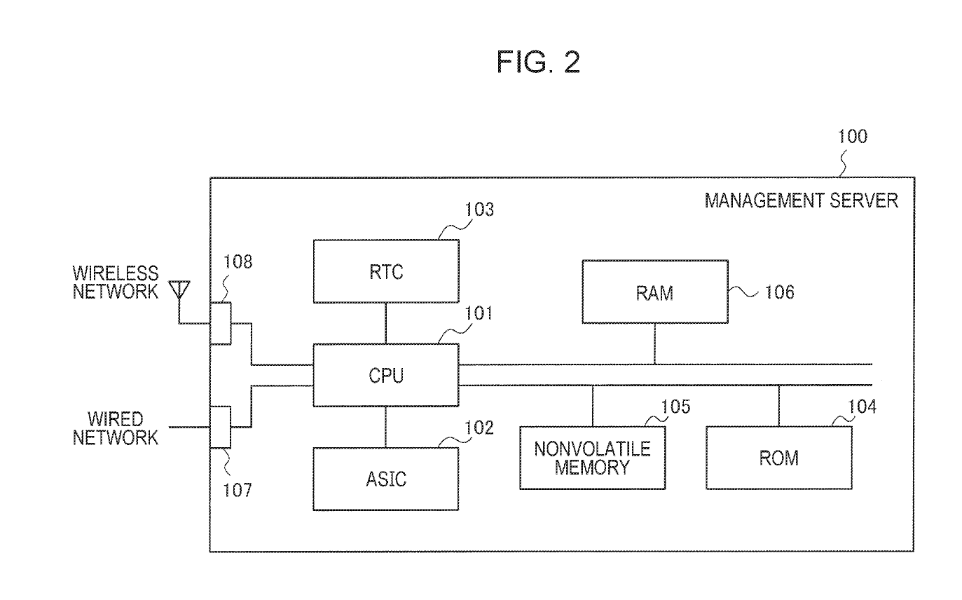

FIG. 2 is a diagram illustrating the hardware configuration of the management server 100. The management server 100 illustrated in FIG. 2 includes a central processing unit (CPU) 101, an application specific integrated circuit (ASIC) 102, and a real-time clock (RTC) 103. The management server 100 also includes, as memories, a read only memory (ROM) 104, a nonvolatile memory 105 in which data may be rewritten, and a random access memory (RAM) 106. Programs performed by the CPU 101 are stored in the ROM 104. The CPU 101 reads programs from the ROM 104 for execution so that various types of processing and control are performed. Further, the management server 100 includes a network adapter 107 and a wireless communication module 108 as network interfaces for connection with the network 300.

The CPU 101 that acts as a controller controls connection with the network 300 and various functions of the management server 100. In addition, the CPU 101 that acts as a processing section performs processing of data obtained over the network 300 and various processes based on functions of the management server 100. The ASIC 102 is a processor that performs processing and control that are specified in advance. Specific information about the processing and control performed by the ASIC 102 is determined by the functions, the specification, and the like of the management server 100. For example, the ASIC 102 may be used for control of a user interface (not illustrated).

The RTC 103 is a clock that presents time data (for example, year, month, day, hour, minute, and second) that is time information, and is an exemplary time management unit that manages time information. The RTC 103 operates with its own power supply (battery). Therefore, even when the power supply of the management server 100 is turned off, the RTC 103 continues to update time data.

As described above, the ROM 104 is used to store the programs performed by the CPU 101. The ROM 104 is also used to store parameters and the like required for processes performed by the CPU 101. The nonvolatile memory 105 holds data generated, for example, as a result of processing performed by the CPU 101. The RAM 106 is used, for example, as a work memory of the CPU 101. The RAM 106 is also used to temporarily hold data generated, for example, as a result of processing performed by the CPU 101.

The network adapter 107 is a connection section for connection with the network 300 through wired communication, and is implemented by using a network interface card (NIC) and the like. The wireless communication module 108 is a connection section for connection with the network 300 through wireless communication. Multiple wireless communication modules may be provided in accordance with communication systems that are to be used, such as Wi-Fi and Bluetooth. These connection sections are an exemplary communication unit for communicating with the terminal apparatuses 200 that are external apparatuses for the management server 100 and communicating with external servers (not illustrated).

The exemplary configuration illustrated in FIG. 2 is merely an exemplary hardware configuration of the management server 100. The configuration of the management server 100 according to the exemplary embodiment is not limited to the exemplary configuration illustrated in FIG. 2. For example, the management server 100 according to the exemplary embodiment does not necessarily include the ASIC 102, and the CPU 101 may perform all of the control and processing. In addition, the memory configuration of the management server 100 according to the exemplary embodiment is not limited to the configuration illustrated in FIG. 2. Further, the management server 100 according to the exemplary embodiment may include, for example, a display mechanism for outputting results of processing performed by the CPU 101, a display, a voice output mechanism, and an input device through which an operator (administrator) inputs instructions and information.

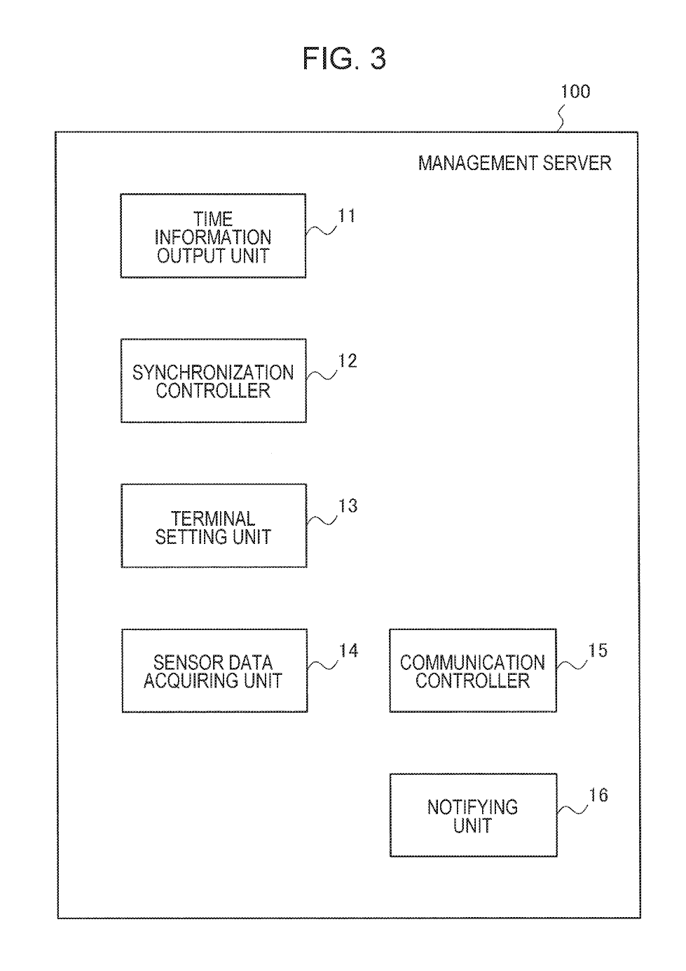

FIG. 3 is a diagram illustrating the functional configuration of the management server 100. As illustrated in FIG. 3, the management server 100 includes a time information output unit 11, a synchronization controller 12, a terminal setting unit 13, a sensor data acquiring unit 14, a communication controller 15, and a notifying unit 16.

The time information output unit 11 is implemented, for example, in such a manner that the CPU 101 illustrated in FIG. 2 performs programs. The time information output unit 11 obtains time data from the RTC 103, and transmits the time data to the terminal apparatuses 200 along with an instruction to perform synchronization. Each of the terminal apparatuses 200 sets its time on the basis of the time data transmitted from the management server 100. Thus, synchronization between time information owned by the management server 100 and time information owned by the terminal apparatus 200 is maintained. The time data is transmitted, for example, when authentication setting (pairing) is performed between the management server 100 and the terminal apparatus 200 in order to recognize each other on the network 300. The time data may be transmitted regularly, such as every a few days or every a few weeks.

The synchronization controller 12 is implemented, for example, in such a manner that the CPU 101 illustrated in FIG. 2 performs programs. When the management server 100 satisfies a predetermined condition and establishes a connection with each of the terminal apparatuses 200, the synchronization controller 12 which is an exemplary time condition setting unit performs synchronization control on the terminal apparatus 200. The predetermined condition may be, for example, a predetermined timing condition. In this case, synchronization control may be performed, for example, at a specific time once a day, or every a few hours. When it is time to perform synchronization control (the timing condition is satisfied), the synchronization controller 12 receives time information from the terminal apparatus 200. The time information indicates time measured by the terminal apparatus 200 that has been synchronized on the basis of the time data transmitted by the time information output unit 11. Then, the synchronization controller 12 compares the time information received from the terminal apparatus 200 with the time data obtained from the RTC 103, and determines whether or not a difference occurs. When a difference occurs, the synchronization controller 12 transmits difference information, such as +n seconds (n seconds earlier) or −n seconds (n seconds later), to the terminal apparatus 200. Upon receiving the difference information, the terminal apparatus 200 corrects the time information on the basis of the received information.

The terminal setting unit 13 is implemented, for example, in such a manner that the CPU 101 illustrated in FIG. 2 performs programs. The terminal setting unit 13 transmits, to each of the terminal apparatuses 200, an instruction to set a timing at which synchronization control is performed (timing condition) and a timing at which the terminal apparatus 200 transmits, to the management server 100, data (hereinafter referred to as sensor data) obtained by using various sensors. Thus, the terminal apparatus 200 is set so as to transmit, at a specific timing that is set in accordance with the setting instruction, time information used in the synchronization control, and so as to transmit sensor data to the management server 100. A timing at which the terminal apparatus 200 transmits sensor data may be set in accordance with the type of the terminal apparatus 200, the types of the sensors mounted in the terminal apparatus 200, the type of a target from which the sensors of the terminal apparatus 200 are to obtain environmental information, and the like. Examples of the timing that may be set include every a few minutes, every a few hours, and a specific time every day. The setting instruction is transmitted, for example, when authentication setting is performed between the management server 100 and the terminal apparatus 200. In addition, in transmission of time data from the time information output unit 11 to the terminal apparatus 200, the setting instruction may be transmitted along with the time data. In the case where settings for a timing at which the terminal apparatus 200 transmits sensor data are to be changed, for example, the setting instruction may be transmitted when communication between the management server 100 and the terminal apparatus 200 may be performed in operations of the synchronization controller 12, the sensor data acquiring unit 14, and the like.

The sensor data acquiring unit 14 is implemented, for example, in such a manner that the CPU 101 illustrated in FIG. 2 performs programs. The sensor data acquiring unit 14 is in a state (hereinafter referred to as a reception-enabled state) in which data may be received, for periods corresponding to the timings at which the terminal apparatuses 200 transmits sensor data on the basis of the settings made by the terminal setting unit 13, and receives the sensor data transmitted from the terminal apparatuses 200 in the periods. The obtained sensor data is stored, for example, in a memory, such as the nonvolatile memory 105 or the RAM 106 illustrated in FIG. 2. The sensor data acquiring unit 14 is in the reception-enabled state in a certain duration including at least one timing at which one or more terminal apparatuses 200 transmit sensor data and which is set by the terminal setting unit 13. The duration that is set for the reception-enabled state is determined, for example, in accordance with the specification of the management server 100 or the specification of the entire system including the terminal apparatuses 200.

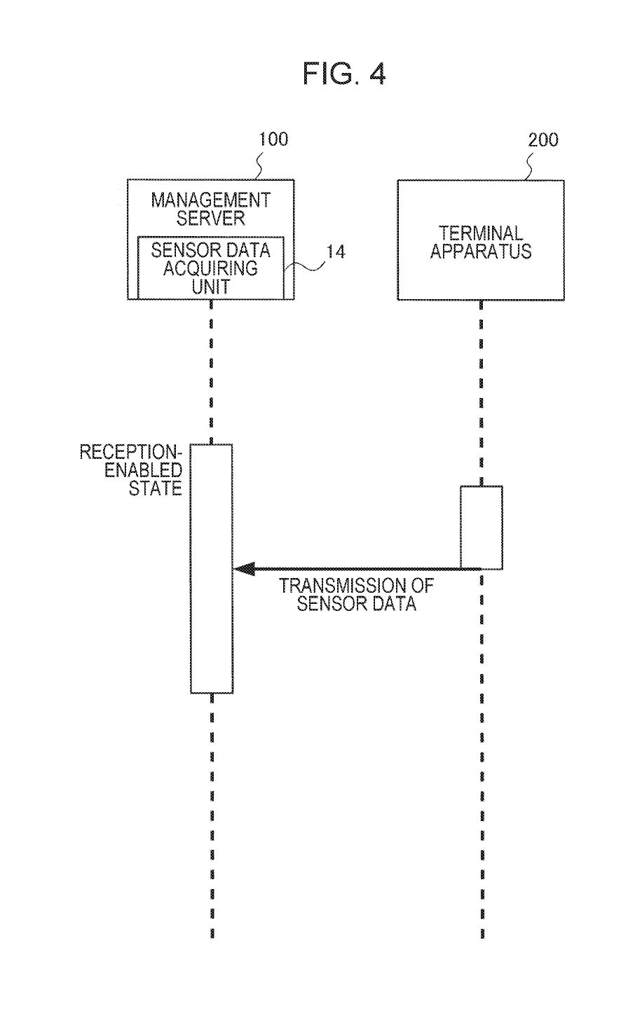

FIG. 4 is a diagram illustrating a relationship between a period for which the sensor data acquiring unit 14 is in the reception-enabled state and a period (timing) in which a terminal apparatus 200 transmits sensor data. As illustrated in FIG. 4, in a certain duration in which the sensor data acquiring unit 14 is in the reception-enabled state, sensor data is transmitted from the terminal apparatus 200 to the management server 100. Thus, even when time measured by a terminal apparatus 200 deviates from the time indicated by the RTC 103 of the management server 100, if the difference falls in a certain amount of deviation width, sensor data transmitted from the terminal apparatus 200 is obtained by the sensor data acquiring unit 14.

The communication controller 15 is implemented, for example, in such a manner that the CPU 101 illustrated in FIG. 2 performs programs. The communication controller 15 controls the network adapter 107 and the wireless communication module 108 so as to communicate with the terminal apparatuses 200 and external servers (not illustrated) over the network 300. That is, data and instructions that are output by the time information output unit 11, the synchronization controller 12, and the terminal setting unit 13 are transmitted to the terminal apparatuses 200 through control of the communication controller 15. Received sensor data and time information are transmitted to the sensor data acquiring unit 14 and the synchronization controller 12 through control of the communication controller 15. When there is an external server that processes sensor data obtained from the terminal apparatuses 200, the communication controller 15 establishes a connection with the external server over the network 300, and transmits the sensor data that is to be processed.

The notifying unit 16 is implemented, for example, in such a manner that the CPU 101 illustrated in FIG. 2 performs programs. The notifying unit 16 detects a terminal apparatus 200 that is not operating normally, and notifies information about the detected terminal apparatus 200 to an operator (administrator) of the management server 100. When communication with a terminal apparatus 200 based on a predetermined condition is not performed normally, the notifying unit 16 determines that the terminal apparatus 200 is not operating normally. That is, the notifying unit 16 also functions as an exemplary determination unit that determines whether or not a terminal apparatus 200 is operating normally. For example, when the sensor data acquiring unit 14 does not receive sensor data in a predetermined number of periods in which sensor data of a specific terminal apparatus 200 may be received, it may be determined that the terminal apparatus 200 is not operating normally. In the synchronization control performed by the synchronization controller 12, when time information is not received from a terminal apparatus 200, it may be determined that the terminal apparatus 200 is not operating normally.

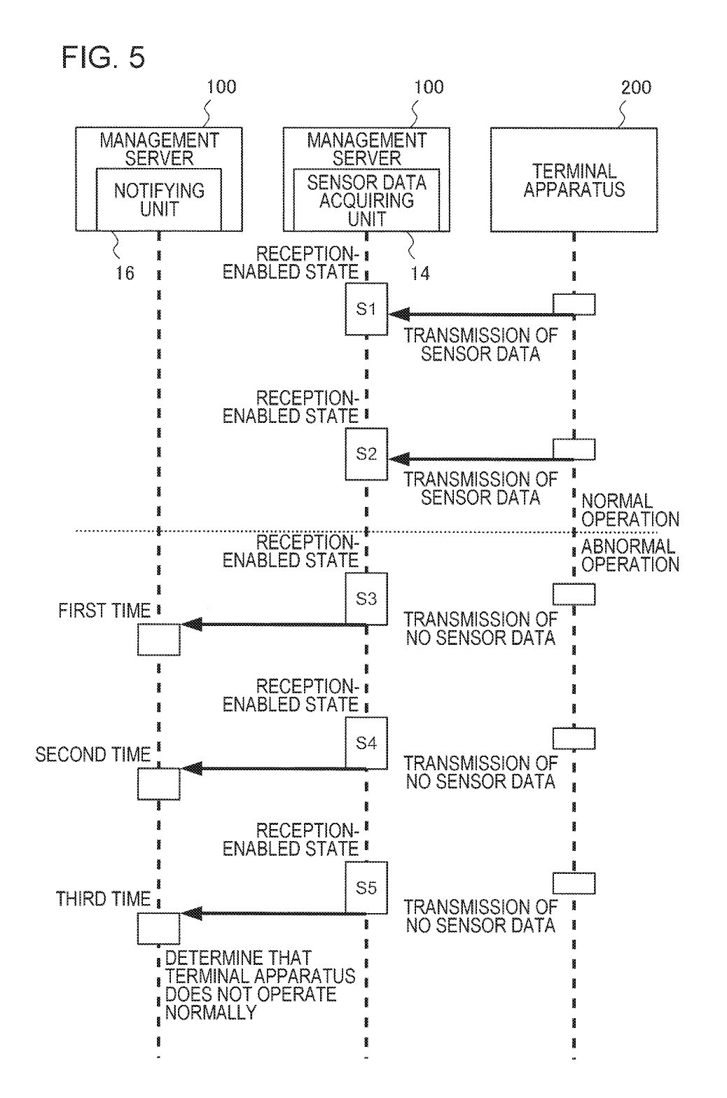

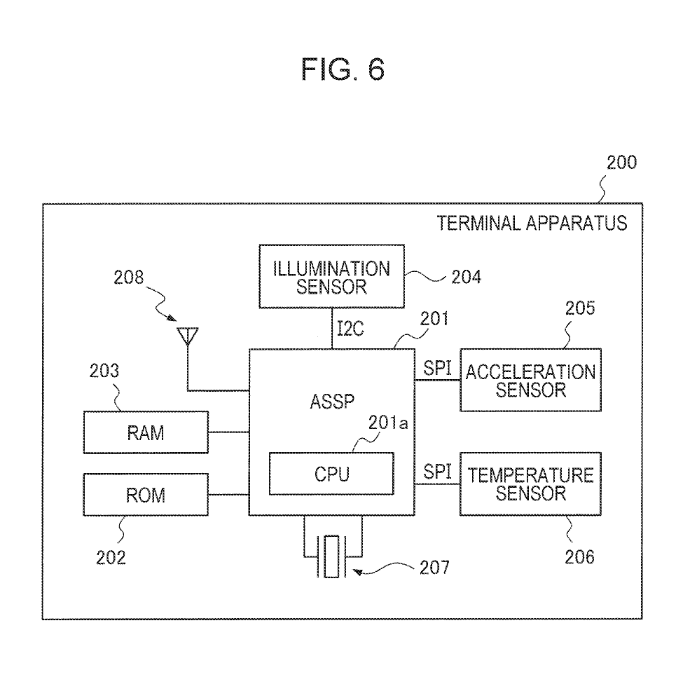

FIG. 5 is a diagram illustrating how the notifying unit 16 detects a terminal apparatus 200 that is not operating normally. In the example in FIG. 5, the sensor data acquiring unit 14 of the management server 100 regularly enters the reception-enabled state. In addition, a terminal apparatus 200 regularly transmits sensor data to the management server 100. In the example illustrated in FIG. 5, the sensor data acquiring unit 14 receives sensor data from the terminal apparatus 200 in reception-enabled states S1 and S2, but does not receive sensor data from the terminal apparatus 200 in reception-enabled state S3 and its subsequent reception-enabled states. After reception-enabled state S5, when it is determined that sensor data has not been received in a series of reception-enabled states (three states in FIG. 6), the notifying unit 16 determines that the terminal apparatus 200 is not operating normally, and transmits a notification. The exemplary operation illustrated in FIG. 5 is merely exemplary. The condition for determining that a terminal apparatus 200 is not operating normally is not limited to the example illustrated in FIG. 6.

The notifying unit 16 notifies information about a terminal apparatus 200 that is not operating normally, for example, in such a manner that the notification is displayed on a display section such as a display (not illustrated) provided on the management server 100, or in such a manner that a message is transmitted to an operation terminal of an operator (administrator) of the management server 100 over the network 300. For example, the notifying unit 16 generates a list of terminal apparatuses 200 that are determined not to be operating normally, and causes a memory, such as the nonvolatile memory 105 or the RAM 106, to hold the list. When the notifying unit 16 receives an operation performed on an operation section (not illustrated) provided on the management server 100, the notifying unit 16 displays, on the display section, the list held in the memory.

As described above, in the management server 100, the time information output unit 11, the synchronization controller 12, the terminal setting unit 13, and the sensor data acquiring unit 14 operate only in predetermined periods. The communication controller 15 and the notifying unit 16 operate only when control and processes for the respective functions are performed. In the management server 100, an operation mode in which the network adapter 107 and the wireless communication module 108 which are a communication unit may be controlled by using these functions is referred to as the normal mode, and an operation mode in which the network adapter 107 and the wireless communication module 108 that are a communication unit are not controlled is referred to as the standby mode. When operations based on these functions are not performed (when the mode is the standby mode), the operation mode of the management server 100 may be further changed to the power saving mode in which power supply for unnecessary functions is stopped.

### The Configuration of a Terminal Apparatus

FIG. 6 is a diagram illustrating the hardware configuration of a terminal apparatus 200. The terminal apparatus 200 illustrated in FIG. 6 includes an application specific standard product (ASSP) 201, and a ROM 202 and a RAM 203 that are memories. The terminal apparatus 200 also includes an illumination sensor 204, an acceleration sensor 205, and a temperature sensor 206 that serve as an information acquiring section, and also includes an oscillator 207 that serves as a timer. The terminal apparatus 200 also includes an antenna 208 for connection with the network 300 through wireless communication.

The ASSP 201 is a processor that performs processing and control that are specified in advance. In the example in FIG. 6, a CPU 201a is mounted in the ASSP 201. Thus, functions of the ASSP 201 may be added or changed by using programs. The ROM 202 is used to store, for example, programs executed by the CPU 201a of the ASSP 201, parameters required in processes of the ASSP 201 and the CPU 201a, and the like. The RAM 203 is used, for example, as a work memory of the ASSP 201 and the CPU 201a. The RAM 203 is also used to hold data generated, for example, as results of processing performed by the ASSP 201 and the CPU 201a.

The illumination sensor 204 is a sensor that measures brightness around the terminal apparatus 200. In the example in FIG. 6, the illumination sensor 204 is connected to the ASSP 201 through an inter-integrated circuit (I2C). As the illumination sensor 204, various existing illumination sensors may be used in accordance with the environmental condition and the like of the location at which the terminal apparatus 200 is installed. The acceleration sensor 205 is a sensor that measures acceleration produced with a movement and an operation of the terminal apparatus 200. In the example in FIG. 6, the acceleration sensor 205 is connected to the ASSP 201 through a serial peripheral interface (SPI). As the acceleration sensor 205, various existing acceleration sensors may be used in accordance with operations of the terminal apparatus 200 and the environmental condition and the like of the location at which the terminal apparatus 200 is installed. The temperature sensor 206 is a sensor that measures temperature around the terminal apparatus 200. In the example in FIG. 6, the temperature sensor 206 is connected to the ASSP 201 through a serial peripheral interface (SPI). As the temperature sensor 206, various existing temperature sensors may be used in accordance with the environmental condition and the like of the location at which the terminal apparatus 200 is installed.

The oscillator 207 generates clock signals for measuring time. By counting the clock signals generated by the oscillator 207, the ASSP 201 recognizes time having elapsed from a certain time point. Therefore, the ASSP 201 and the oscillator 207 function as a timer section that measures a lapse of time.

The antenna 208 receives/transmits radio waves for connection with the network 300 through a wireless communication line on the basis of control of the ASSP 201. Therefore, the ASSP 201 and the antenna 208 function as a communication section (wireless communication module) of the terminal apparatus 200.

The exemplary configuration in FIG. 6 is merely an exemplary hardware configuration of the terminal apparatus 200. The configuration of the terminal apparatus 200 according to the exemplary embodiment is not limited to the exemplary configuration in FIG. 6. For example, in the exemplary configuration in FIG. 6, the terminal apparatus 200 includes three types of sensors, i.e., the illumination sensor 204, the acceleration sensor 205, and the temperature sensor 206. Instead of this configuration, one or two types of sensors may be included. Alternatively, four or more types of sensors may be included. In addition, a sensor such as a humidity sensor which is not illustrated may be included. Further, interfaces (paths) connecting between the sensors and the ASSP 201 are not limited to an I2C and a SPI which are illustrated. In addition, the terminal apparatus 200 illustrated in FIG. 6 is connected to the network 300 through a wireless communication line. A network adapter may be provided, and the terminal apparatus 200 may be connected to the network 300 through a wired communication line.

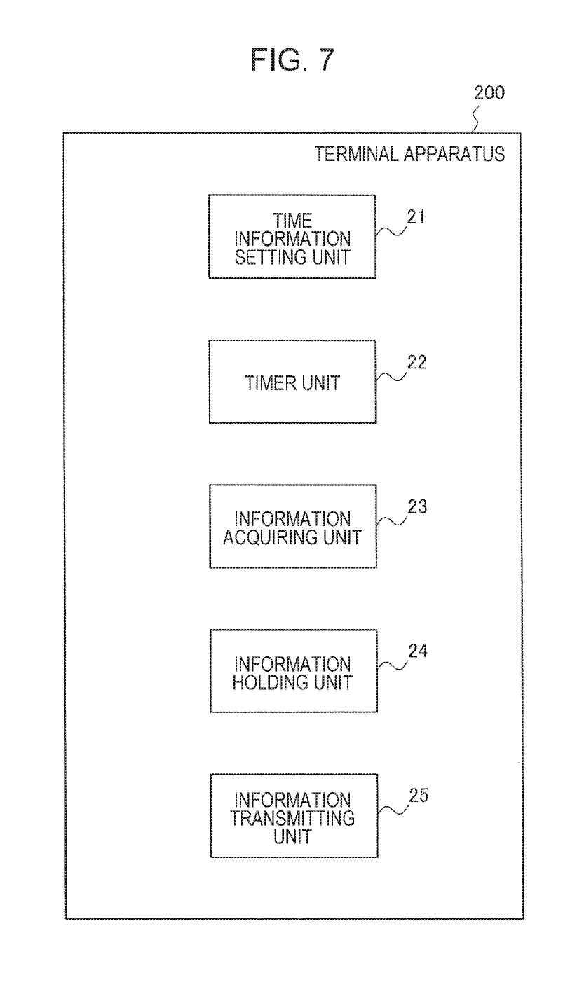

FIG. 7 is a diagram illustrating the functional configuration of a terminal apparatus 200. As illustrated in FIG. 7, the terminal apparatus 200 includes a time information setting unit 21, a timer unit 22, an information acquiring unit 23, an information holding unit 24, and an information transmitting unit 25.

The time information setting unit 21 is implemented, for example, by using the ASSP 201 (CPU 201a), the RAM 203, and the antenna 208 that are illustrated in FIG. 6. The time information setting unit 21 receives time data that is output from the time information output unit 11 of the management server 100, and sets time in the terminal apparatus 200. Specifically, the ASSP 201 stores the received time data in the RAM 203. The ASSP 201 determines time on the basis of the time data stored in the RAM 203. The time data is received, for example, when authentication setting (pairing) for recognizing each other on the network 300 is performed between the terminal apparatus 200 and the management server 100. The time data may be received regularly, such as every a few days or every a few weeks. In addition, the time information setting unit 21 receives time difference information transmitted from the synchronization controller 12 of the management server 100 on the basis of a specific timing condition serving as a time adjustment condition, and updates the time data stored in the RAM 203 on the basis of the received difference information.

The timer unit 22 is implemented, for example, by using the ASSP 201 (CPU 201a), the RAM 203, and the oscillator 207 that are illustrated in FIG. 6. The timer unit 22 measures elapsed time on the basis of the clock signals generated by the oscillator 207. The timer unit 22 specifies the current time (time information) in the terminal apparatus 200 on the basis of the measured elapsed time and the time data stored in the RAM 203 by the time information setting unit 21.

The information acquiring unit 23 is implemented, for example, by using the sensors 204, 205, and 206 and the ASSP 201 (CPU 201a) that are illustrated in FIG. 6. The information acquiring unit 23 obtains sensor data obtained through detection performed by the sensors 204, 205, and 206. The information acquiring unit 23 may obtain detection results of the sensors 204, 205, and 206 all the time in accordance with the specification of the terminal apparatus 200 and the type or the like of a target from which the sensors 204, 205, and 206 are to obtain environmental information. Alternatively, the information acquiring unit 23 may obtain the detection results when a specific condition is satisfied.

The information holding unit 24 is implemented, for example, by using the ASSP 201 (CPU 201a) and the RAM 203 that are illustrated in FIG. 6. The information holding unit 24 holds sensor data obtained by the information acquiring unit 23.

The information transmitting unit 25 is implemented, for example, by using the ASSP 201 (CPU 201a), the RAM 203, and the antenna 208 that are illustrated in FIG. 6. The information transmitting unit 25 transmits the sensor data held by the information holding unit 24 and information about the current time specified by the timer unit 22, to the management server 100 at respective timings specified by the setting instruction received from the management server 100. Specifically, the information transmitting unit 25 transmits the sensor data on the basis of the timing condition (communication-enabled condition) which is used to transmit sensor data and which is specified by the setting instruction. The communication-enabled condition may be, for example, a setting indicating a condition that is regularly satisfied, such as every hour. The information transmitting unit 25 transmits information about the current time specified by the timer unit 22 on the basis of the timing condition (time adjustment condition) which is used to transmit time information (information used in the synchronization control performed by the synchronization controller 12 of the management server 100) and which is specified by the setting instruction. The time adjustment condition may be, for example, a setting indicating a condition that is regularly satisfied, such as a specific time every day. The communication-enabled condition and the time adjustment condition are obtained from the setting instruction transmitted from the terminal setting unit 13 of the management server 100, and are stored, for example, in the RAM 203.

A case in which the information transmitting unit 25 fails to transmit sensor data to the management server 100 will be discussed. For example, either of the following cases may occur: a case in which the management server 100 has not entered the reception-enabled state because the current time specified by the timer unit 22 of the terminal apparatus 200 deviates from the time indicated by the RTC 103 of the management server 100; a case in which the power supply of the management server 100 has been turned off; and a case in which a failure occurs in a communication line. In this case, either of the following two types of control may be employed: a type of control in which the information holding unit 24 continues to hold the sensor data that had been to be transmitted, and in which the sensor data is transmitted along with newly obtained sensor data at the next timing at which sensor data is transmitted; and a type of control in which the sensor data that had been to be transmitted is discarded, and in which only newly obtained sensor data is transmitted at the next timing at which sensor data is transmitted. Which type of control is to be employed is determined, for example, in accordance with the specification of the terminal management system 10, the type of the terminal apparatus 200 or the types of the sensors mounted in the terminal apparatus 200, and the type of a target from which the sensors of the terminal apparatus 200 are to obtain environmental information.

As described above, in a terminal apparatus 200, operations of the time information setting unit 21 and the information transmitting unit 25 which concern communication with the management server 100 are performed only in periods specified on the basis of the setting instruction received from the management server 100. Therefore, compared with a configuration in which communication with the management server 100 is ready to be performed all the time, the amount of power consumption in the terminal apparatus 200 is reduced. Assume that a configuration is employed in which, instead of obtaining detection results of the sensors 204, 205, and 206 all the time, the information acquiring unit 23 obtains the information in accordance with a predetermined condition or rule (for example, at regular intervals). In this case, in a period in which the information is not obtained, the operation mode of the terminal apparatus 200 may be changed to the power saving mode in which power supply to unnecessary functions is stopped.

### Exemplary Application of the Management Server

In the exemplary embodiment, as long as the management server 100 is an information processing apparatus that establishes a connection with the terminal apparatuses 200 over the network 300 and that has a function of managing the terminal apparatuses 200, any configuration may be employed. The management server 100 is implemented, for example, by using a personal computer, a server machine, or any of various information processing apparatuses provided with a communication function. For example, a configuration in which an image processing apparatus that is a multifunction device is used as the management server 100 will be described. The multifunction device is provided with a copying function, an image reading function, a printing function, a fax communication function, and the like, and is also provided with a communication function for performing data communication over the network 300.

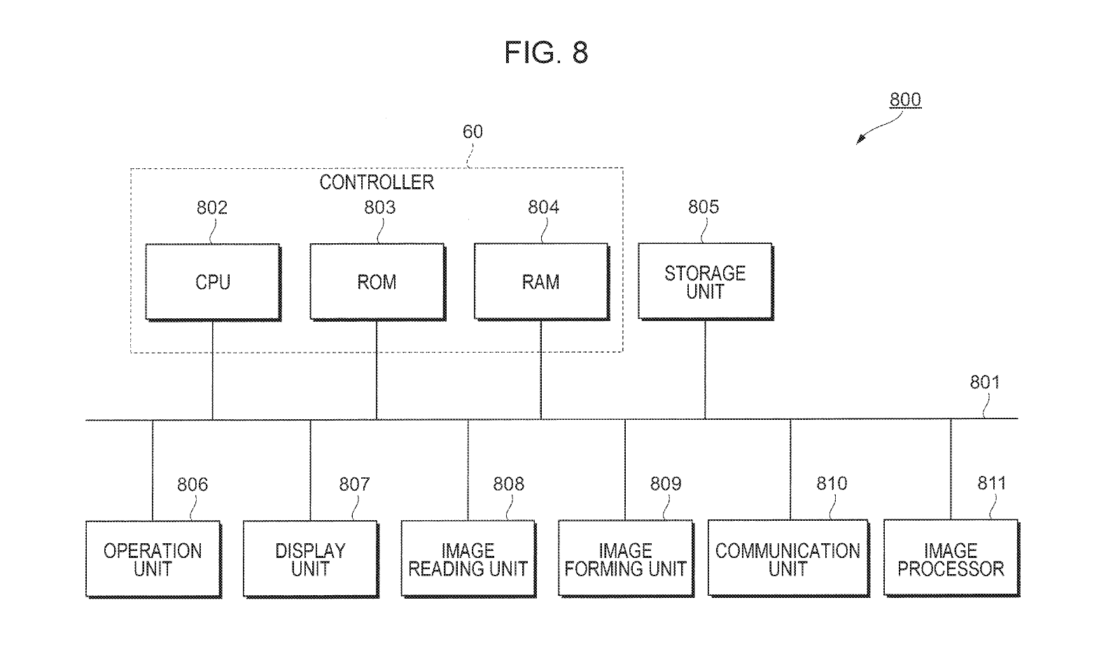

FIG. 8 is a diagram illustrating the functional configuration of a multifunction device that is an exemplary management server 100. In the configuration illustrated in FIG. 8, a multifunction device 800 that is the management server 100 includes a CPU 802, a ROM 803, and a RAM 804 that form a controller 60. The multifunction device 800 also includes a storage unit 805, an operation unit 806, a display unit 807, an image reading unit 808, an image forming unit 809, a communication unit 810, and an image processor 811. The functional units are connected to a bus 801, and receives/transmits data through the bus 801.

The operation unit 806 receives operations from a user. The operation unit 806 is constituted, for example, by hardware keys. The operation unit 806 is constituted, for example, by a touch sensor that outputs a control signal according to a position of a touch. The operation unit 806 may be constituted as a touch panel obtained by combining the touch sensor and a liquid-crystal display included in the display unit 807 described below.

The display unit 807 is an exemplary display section, and is constituted, for example, by a liquid-crystal display. The display unit 807 displays information about the multifunction device 800 under control of the CPU 802. The display unit 807 displays a menu screen referred to by a user when the user operates the multifunction device 800. That is, a combination of the above-described operation unit 806 and the display unit 807 functions as a user interface unit of the multifunction device 800.

The image reading unit 808 including a so-called scanner device optically reads an image on a document that has been set, and generates a read image (image data). As a system of reading an image, for example, a charge coupled device (CCD) system or a contact image sensor (CIS) system is used. The CCD system is a system in which reflected light obtained by reflecting light emitted from a light source to a document is reduced by using a lens and is received by CCDs. The CIS system is a system in which reflected light obtained by reflecting light that is sequentially emitted from a light emitting diode (LED) light source to a document is received by a CIS.

The image forming unit 809 that is an exemplary image forming section forms an image based on image data by using image forming material on a sheet of paper that is exemplary recording material. As a system of forming an image on recording material, for example, an electrophotographic system in which toner attached to a photoreceptor is transferred to recording material so that an image is formed, an inkjet system in which ink is ejected onto recording material so that an image is formed, or the like is used.

The communication unit 810 includes a network interface for connection with the terminal apparatuses 200 over the network 300. As described with reference to FIG. 2, a network adapter, a wireless communication module, and the like are provided as an exemplary network interface (not illustrated). The communication unit 810 includes a communication module for fax communication and the like. The communication unit 810 may include a module for communication using the LTE or the 3G.

The image processor 811 includes a processor that is a computing section and a work memory, and performs image processing, such as color correction and tone correction, on an image represented by image data. The CPU 802 of the controller 60 may be also used as the processor, and the RAM 804 of the controller 60 may be also used as the work memory.

The storage unit 805 that is an exemplary memory includes, for example, a storage device such as a hard disk device. The storage unit 805 stores image data such as a read image generated by the image reading unit 808. The storage unit 805 according to the exemplary embodiment stores information for connecting the multifunction device 800 to the terminal apparatuses 200.

The CPU 802, the ROM 803, and the RAM 804 form the controller 60. The ROM 803 is used to store programs executed by the CPU 802. The CPU 802 reads the programs stored in the ROM 803, and uses the RAM 804 as a work area to execute the programs. The CPU 802 may read the programs stored in the storage unit 805 onto the RAM 804, and may executes the programs that have been read onto the RAM 804. The CPU 802 executes the programs. Thus, the above-described functional units of the multifunction device 800 are controlled, and the following functions are implemented.

The programs executed by the CPU 802 may be provided to the multifunction device 800 that serves as the management server 100, by storing the programs in a computer-readable recording medium, such as a magnetic recording medium (such as a magnetic disk), an optical recording medium (such as an optical disk), or a semiconductor memory. The programs executed by the CPU 802 may be provided to the multifunction device 800 serving as the management server 100, over a network such as the Internet.

When the multifunction device 800 illustrated in FIG. 8 is used as the management server 100, the time information output unit 11, the synchronization controller 12, the terminal setting unit 13, the sensor data acquiring unit 14, the communication controller 15, and the notifying unit 16 are implemented, for example, in such a manner that the CPU 802 of the controller 60 executes the programs stored in the ROM 803. As a memory used to store sensor data obtained by the sensor data acquiring unit 14, for example, the RAM 804 or the storage unit 805 is used. As a communication section controlled by the communication controller 15, for example, the communication unit 810 is used. As a display section using which the notifying unit 16 notifies information about a terminal apparatus 200 that is not operating normally, for example, the display unit 807 is used.

### Exemplary Operations in Communication Between the Management Server and a Terminal Apparatus

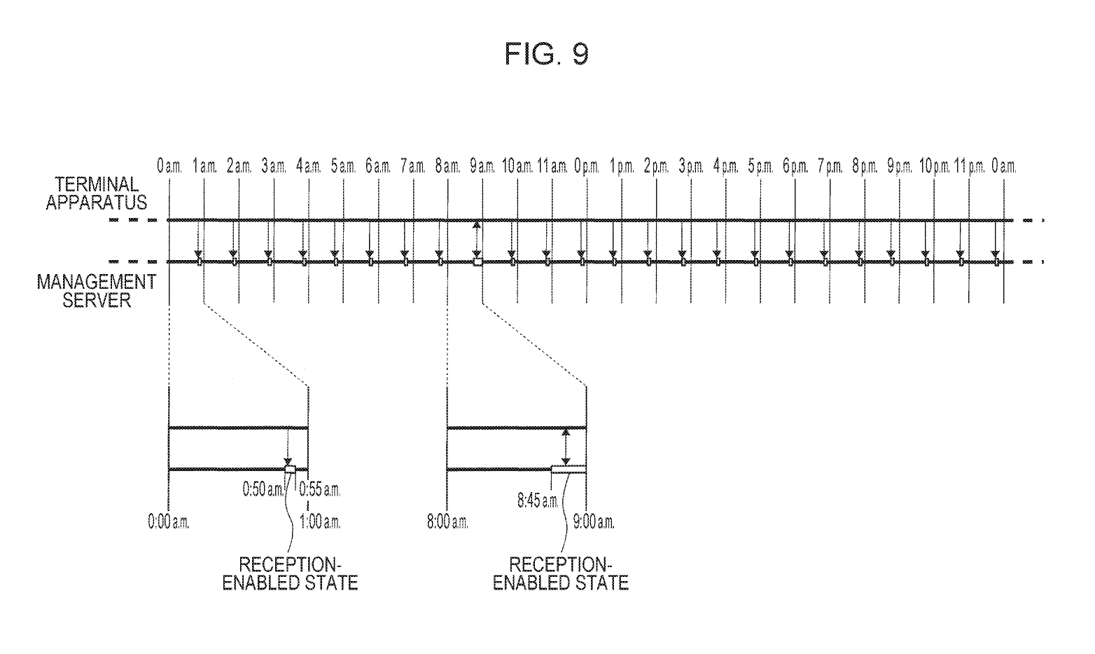

FIG. 9 is a diagram illustrating a form of communication between the management server 100 and a terminal apparatus 200. In the example in FIG. 9, the management server 100 is in the reception-enabled state only for a certain period every hour (in the illustrated example, for five minutes from 50 to 55 minutes past the hour, except for 8:00 a.m.). The management server 100 is in the reception-enabled state for a period (in the illustrated example, 15 minutes from 8:45 a.m. to 9:00 a.m.) longer than the period of the other reception-enabled states, at a specific time every day. The terminal apparatus 200 transmits sensor data to the management server 100 at a time that is set in a period from 50 and 55 minutes past every hour. At the specific time, not only reception/transmission of sensor data but also synchronization control by the synchronization controller 12 of the management server 100 is performed.

In the example in FIG. 5, when sensor data has not been received in a series of reception-enabled states, it is determined that the terminal apparatus 200 is not operating normally. In contrast, in the exemplary operation illustrated in FIG. 9, when communication between the management server 100 and a terminal apparatus 200 fails in a reception-enabled state in the specific period (from 8:45 a.m. to 9:00 a.m.) in which synchronization control is performed, it is possible to affect communication in another period because synchronization control has not been performed. Therefore, it may be determined that the terminal apparatus 200 is not operating normally even when only a single communication failure occurs.

The exemplary operation illustrated in FIG. 9 is merely an exemplary communication form between the management server 100 and a terminal apparatus 200. A form of communication between the management server 100 and a terminal apparatus 200 in the terminal management system 10 according to the exemplary embodiment is not limited to the example illustrated in FIG. 9. For example, in the example illustrated in FIG. 9, communication between the management server 100 and a terminal apparatus 200 is performed every hour in a 24-hour period. Alternatively, control may be exerted so that communication between the management server 100 and a terminal apparatus 200 is not performed for a specific period (for example, 9:00 p.m. to 8:00 a.m. the next day). Intervals at which communication between the management server 100 and a terminal apparatus 200 is performed, and the time length of the reception-enabled state of the management server 100 are not limited to the example illustrated in FIG. 9.

### Modified Examples

In the exemplary embodiment, a single management server 100 is associated with multiple terminal apparatuses 200, and sensor data and the like are transmitted from each of the terminal apparatuses 200 to the management server 100. Therefore, it is necessary to provide a way to avoid collision of transmission data which occurs when multiple terminal apparatuses 200 transmit data to the management server 100 at the same time. For example, carrier sense multiple access/collision avoidance (CSMA/CA) used as a wireless LAN communication protocol is applied. In CSMA/CA, each terminal apparatus 200 monitors the usage of a communication line, and performs communication when the communication line is available (when the other terminal apparatuses 200 do not perform communication). In the case where the communication line is busy, the terminal apparatus 200 starts communication after waiting time has elapsed from a time point at which the communication line becomes available. The length of the waiting time is typically set at random in CSMA/CA. However, certain fixed waiting time may be set. For example, when waiting time that is set at random in CSMA/CA is either of 5 milliseconds (mS), 10 mS, and 15 mS, if fixed waiting time of 5 mS is set, waiting time of 10 mS and waiting time of 15 mS are not assigned, achieving reduction in power consumption in a transmission standby state.

An applicable way to avoid collision of transmission data which occurs when multiple terminal apparatuses 200 transmit data to the management server 100 at the same time is not limited to CSMA/CA described above. For example, while a communication frequency is switched (frequency hopping), data may be transmitted at frequencies at which communication may be performed. Other than this, various existing methods used to avoid collision of transmission data in communication (especially, wireless communication) may be used.

In the above-described exemplary embodiment, a system (push type) in which a period in which the management server 100 communicates with the terminal apparatuses 200 is set, and in which the terminal apparatuses 200 transmit sensor data and the like in the set period is employed. A system (pull type) in which the management server 100 accesses the terminal apparatuses 200 at a time that is not in the set period (in an asynchronous manner), on the basis of a request and the like transmitted from an external server will be discussed. In this case, the terminal apparatuses 200 need a mechanism for recognizing a connection request transmitted from the management server 100.

For example, a configuration in which a terminal apparatus 200 transmits sensor data and the like to the management server 100 on the condition that the management server 100 has transmitted data having a specific packet length may be employed. That is, the condition using a packet length is applied in addition to the above-described timing condition. In this case, the terminal apparatus 200 includes a section of recognizing a packet length (packet length recognizing section). The packet length recognizing section is implemented, for example, in such a manner that the ASSP 201 (CPU 201a) illustrated in FIG. 6 executes programs. As the packet length recognizing section, a dedicated circuit for recognizing a packet length may be provided. As described by using CSMA/CA, the terminal apparatus 200 monitors the usage of a communication line. When the packet length recognizing section detects communication using data having the specific packet length, the information transmitting unit 25 transmits sensor data and the like regardless of the timing condition.

A configuration in which a terminal apparatus 200 uses a battery as power supply will be discussed. In this case, for example, the operation mode is switched to the special mode in which the information transmitting unit 25 suppresses use of the battery on the condition that the voltage of the battery of the terminal apparatus 200 decreases to a certain value or less (for example, a predetermined threshold or less), i.e., the battery output becomes weak. In the special mode, for example, the information transmitting unit 25 transmits sensor data once every two or every few transmission timings, which are determined on the basis of the communication-enabled condition specified by the setting instruction. In other words, transmission of sensor data is suppressed so that transmission is performed once every two or more transmission timings, which are determined on the basis of the communication-enabled condition. Thus, when a specific terminal apparatus 200 has transmitted sensor data once every two or every few set timings, the management server 100 may detect that the output of the battery of the specific terminal apparatus 200 has weakened. As described with reference to FIG. 5, in the case where it is determined that a terminal apparatus 200 is not operating normally on the condition that a series of reception operations of sensor data has failed, the frequency at which data transmission is skipped in the special mode is set to a frequency less than the frequency used in the determination of whether or not a terminal apparatus 200 is not operating normally. As described with reference to FIG. 9, when a specific period in which communication is performed without exception is set, control is exerted so that data transmission in this period is not skipped.

In the exemplary embodiment, the communication-enabled condition for specifying a timing at which the information transmitting unit 25 of a terminal apparatus 200 transmits sensor data to the management server 100, and the time adjustment condition for specifying a timing at which the information transmitting unit 25 transmits time information to the management server 100 are set in such a manner that the terminal setting unit 13 of the management server 100 transmits a setting instruction to the terminal apparatus 200. Alternatively, these conditions may be set in the terminal apparatus 200 in advance. Specifically, for example, in a manufacture stage of a terminal apparatus 200, the communication-enabled condition and the time adjustment condition may be stored in the ROM 202 illustrated in FIG. 6.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a communication unit that communicates with an external apparatus with which communication is enabled for a limited period; and
a communication controller that, in a predetermined period including a period which is set as the limited period for which communication with the external apparatus is enabled, controls the communication unit so as to establish, for communication, a connection with the external apparatus.

2. The information processing apparatus according to claim 1, further comprising:
a time management unit that manages time information; and
a synchronization controller that, when the communication controller establishes a connection with the external apparatus with a predetermined condition being satisfied, synchronizes time managed by the time management unit with time in the external apparatus.

3. The information processing apparatus according to claim 2,
wherein the synchronization controller obtains time information of the external apparatus from the external apparatus through the communication unit, and, when there is a difference between the obtained time information and the time information managed by the time management unit, notifies, for synchronization, the external apparatus of the difference in the time information.

4. The information processing apparatus according to claim 1, further comprising:
a determination unit that, when communication with the external apparatus based on a predetermined condition is not performed normally, determines that the external apparatus is not operating normally.

5. The information processing apparatus according to claim 4,
wherein, when communication with the external apparatus is not performed in a series of periods, the number of which is predetermined and each of which is the predetermined period, the determination unit determines that the external apparatus is not operating normally.

6. The information processing apparatus according to claim 2, further comprising:
a determination unit that, when communication with the external apparatus is not performed normally over the connection with the external apparatus, the connection being a connection through which synchronization control is performed by the synchronization controller, determines that the external apparatus is not operating normally.

7. An information processing apparatus comprising:
a communication unit that communicates with an external apparatus with which communication is enabled for a limited period; and
a communication controller that has a normal mode and a standby mode as an operation mode, the normal mode being a mode in which the communication unit is controlled, the standby mode being a mode in which the communication unit is not controlled, and that, in a predetermined period including at least a period which is set as the limited period for which communication with the external apparatus is enabled, operates in the normal mode and communicates with the external apparatus.

8. A communication system comprising:
a first device that is provided with a communication function and that enters a communication-enabled state when a predetermined communication-enabled condition is satisfied; and
a second device that is provided with a communication function for communicating with the first device, the second device being in a communication-enabled state for a predetermined period and communicating with the first device, the predetermined period including a period for which the first device is in the communication-enabled state.

9. The communication system according to claim 8,
wherein, when the first device satisfies a predetermined time adjustment condition, the first device transmits time information in the first device to the second device, and
wherein the second device synchronizes the time information in the first device on a basis of the time information in the first device and time information in the second device, the time information in the first device being obtained from the first device.

10. The communication system according to claim 8,
wherein, when power supply voltage is decreased below a predetermined threshold, the first device suppresses communication based on the communication-enabled condition, and performs communication once for a plurality of satisfactory occurrences of the communication-enabled condition.
